(19) United States
(12) Patent Application Publication
(10) Pub. No.: US 2015/0356975 A1
(43) Pub. Date: Dec. 10, 2015

(54) APPARATUS FOR PROCESSING AUDIO SIGNAL FOR SOUND BAR AND METHOD THEREFOR

(71) Applicant: ELECTRONICS AND TELECOMMUNICATIONS RESEARCH INSTITUTE, Yuseong-gu Daejeon (KR)

(72) Inventors: Jeong Il SEO, Daejeon (KR); Dae Young JANG, Daejeon (KR); Tae Jin PARK, Daejeon (KR); Keun Woo CHOI, Daejeon (KR); Kyeong Ok KANG, Daejeon (KR); Jin Woong KIM, Daejeon (KR)

(21) Appl. No.: 14/760,770

(22) PCT Filed: Jan. 15, 2014
(86) PCT No.: PCT/KR2014/000439

§ 371 Date: Jul. 14, 2015

(30) Foreign Application Priority Data
Jan. 15, 2013 (KR) 10-2013-0004360
Aug. 8, 2013 (KR) 10-2013-0094411

(51) Int. Cl. G10L 19/008; H04S 5/00

(52) U.S. Cl. CPC G10L 19/008; H04S 5/00; H04S 2400/01; H04S 2400/03

(57) ABSTRACT

An audio signal processing apparatus and method for reproducing a sound field using a sound bar are disclosed, wherein the audio signal processing apparatus may include an audio signal output unit to process an input signal and output an N channel audio signal and a speak signal generator to generate an M channel speaker signal using an audio signal output position of each channel and the N channel audio signal.

### TECHNICAL FIELD

The present invention relates to an audio signal processing apparatus and method for a sound bar, and more particularly, to an apparatus and a method of converting a multichannel audio signal using channel position information for the multichannel audio signal and forming a virtual channel at a position intended by an audio signal manufacturer.

### BACKGROUND ART

Sound field reproduction refers to technology for reproducing a sound field that may detect a position of a sound source by outputting an audio signal through speakers. A sound bar is a new form of a loudspeaker array in which loudspeakers are linearly connected.

A representative audio signal output format may be a stereo 5.1 channel that is standardized by a standardization group such as International Telecommunication Unit Radio communication sector (ITU-R) or Digital Video Disc (DVD) Forum and thus, a playback position of a speaker may be predetermined. Accordingly, the sound bar may determine each channel signal reproduction position based solely on a type of an input audio signal.

Recently, an audio signal output format has been diversified including Nippon Hoso Kyokai (NHK) 22.2 channel and a number of speakers has been increasing. Dolby Atmos, Moving Picture Experts Group (MPEG)-H three-dimensional (3D) Audio, and the like may provide an audio object signal in addition to a conventional channel signal and thus, the sound bar may not store and use channel positions of all speaker formats. Also, a spatial resolution of a virtual sound field that may be provided by the sound bar may be limited by a characteristic of the speaker array provided in the sound bar. For example, a single horizontal array may not express an elevation. Thus, channel signals that may not be expressed by the sound bar may need to be expressed along with other channel signals.

For example, Korean Patent Publication No. 10-2009-0110598 published on Oct. 22, 2009, discloses a method and devices of reproducing a sound field through a frontal loudspeaker array, for example, a sound bar.

The conventional technology may reproduce a sound field by determining a signal to be radiated in a form of an arc array based on sound field reproduction information. However, when a number of speakers included in a speaker array and a number of channels of a multichannel audio signal included in an input signal differ from each other, reproducing the multichannel audio signal through the speaker array may be limited.

Accordingly, a method of reproducing a multichannel audio signal when a number of speakers included in a sound bar and a number of channels of the multichannel audio signal included in an input signal differ from each other may be required.

### DISCLOSURE OF INVENTION

### Technical Goals

An aspect of the present invention provides an apparatus and a method for adequately expressing a multichannel sound field through a sound bar by transmitting channel position information in addition to a multichannel audio signal when transmitting a signal from a multichannel audio player and a multichannel decoder to the sound bar.

### Technical Solutions

According to an aspect of the present invention, there is provided an audio signal processing apparatus including an audio signal output unit to process an input signal and output an N channel audio signal and a speaker signal generator to generate an M channel speaker signal using an audio signal output position of each channel and the N channel audio signal.

When a value of N is not a number of channels indicating the audio signal output position of each channel, the audio signal output unit may extract channel based reproduction position information from the input signal to output the extracted channel based reproduction position information.

When the N is greater than a value of M, the speaker signal generator may identify an adjacent audio signal based on the audio signal output position of each channel and generate a single speaker signal using adjacent audio signals.

When the value of N is less than the value of M, the speaker signal generator may divide an audio signal and generate a plurality of speaker signals.

The speaker signal generator may process the N channel audio signal using a rendering algorithm based on the audio signal output position of each channel and generate the M channel speaker signal.

When the audio signal output position of each channel is a front channel, the speaker signal generator may process the audio signal using an amplitude/power panning rendering algorithm or a wave field synthesis rendering algorithm and generate at least one speaker signal corresponding to the audio signal.

When the audio signal output position of each channel is a side channel or a back channel, the speaker signal generator may process the audio signal using a head related transfer function rendering algorithm, a beam forming rendering algorithm, or a focused source rendering algorithm and generate at least one speaker signal corresponding to the audio signal.

When the audio signal output position of each channel is a side channel or a back channel, the speaker signal generator may process the audio signal using a beam-forming rendering algorithm and generate at least one speaker signal corresponding to the audio signal.

When the input signal is an encoded audio bitstream, the audio signal output unit may decode an audio bitstream using an audio decoder and output the N channel audio signal.

According to another aspect of the present invention, there is provided an audio signal processing apparatus including an audio signal decoder to decode an N channel audio signal and channel based reproduction position information from an audio bitstream and an audio renderer to render the N channel audio signal into an M channel speaker signal using the channel based reproduction position information and speaker position information with respect to a speaker outputting a speaker signal.

When the channel based reproduction position information differs from the speaker position information, the audio renderer may render the N channel audio signal into the M channel speaker signal based on a difference between the channel based reproduction position information and the speaker position information.

According to still another aspect of the present invention, there is provided an audio signal processing method including outputting an N channel audio signal by processing an input signal and generating an M channel speaker signal using an audio signal output position of each channel and the N channel audio signal.

According to yet another aspect of the present invention, there is provided an audio signal processing method including decoding an N channel audio signal and channel based reproduction position information from an audio bitstream and rendering the N channel audio signal into an M channel speaker signal using the channel based reproduction position information and speaker position information with respect to a speaker outputting a speaker signal.

### Effects of Invention

According to an embodiment of the present invention, when reproducing a sound field through a sound bar, a multichannel audio signal may be converted to a speaker signal using channel position information for the multichannel audio signal and thus, a virtual channel may be formed at a position intended by a manufacturer of an input signal.

Also, when reproducing a sound field in a general speaker environment, an audio signal processing apparatus may convert a multichannel audio signal to a speaker signal using a position of a speaker and channel position information for a multichannel audio signal and thus, a virtual channel may be formed at a position intended by a manufacturer of an input signal although the position of the speaker differs from a position of the channel.

### BRIEF DESCRIPTION OF DRAWINGS

FIG. 1 is a diagram illustrating an audio signal processing apparatus according to an embodiment of the present invention.

FIG. 2 illustrates an example of arrangement of a sound bar of FIG. 1.

FIG. 3 is a diagram illustrating operation of an audio signal processing apparatus according to an embodiment of the present invention.

FIG. 4 illustrates an example of a speaker signal output by a sound bar according to an embodiment of the present invention.

FIG. 5 is a diagram illustrating an audio signal processing apparatus according to another embodiment of the present invention.

FIG. 6 is a diagram illustrating a relationship between an audio signal and a speaker signal according to an embodiment of the present invention.

FIG. 7 is a flowchart illustrating an audio signal processing method according to an embodiment of the present invention.

FIG. 8 is a flowchart illustrating an audio signal processing method according to another embodiment of the present invention.

### BEST MODE FOR CARRYING OUT THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures. An audio signal processing method according to an embodiment of the present invention may be performed by an audio signal processing apparatus.

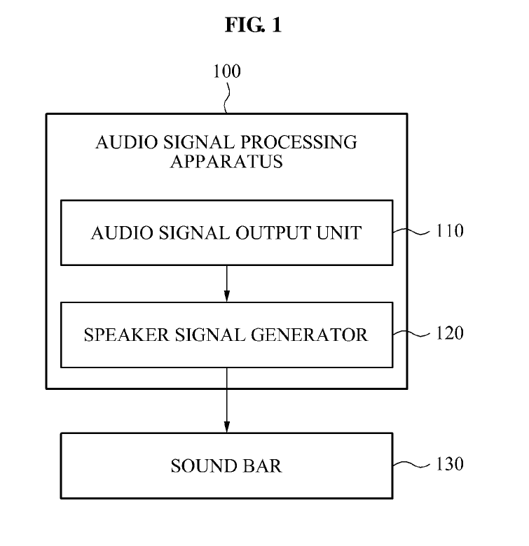

FIG. 1 is a diagram illustrating an audio signal processing apparatus 100 according to an embodiment of the present invention.

Referring to FIG. 1, the audio signal processing apparatus 100 may include an audio signal output unit 110 and a speaker signal generator 120.

The audio signal output unit 110 may process an input signal and output an N channel audio signal. Here, a value of N may indicate a number of all channels of an audio signal output by the audio signal output unit 110 and N may be one of channels used by a multichannel audio signal. For example, N may be one of a 2.0 channel, a 5.1 channel, a 7.1 channel, a 10.2 channel, and a 22.2 channel.

Here, the input signal may include at least one of an analog audio input signal, a digital audio input signal, and an encoded audio bitstream. Also, the audio signal output unit 110 may receive the input signal from a device, for example, a digital video disc (DVD) player, a Blu-ray disc (BD) player, and a moving picture experts group layer 3 (MP3) player.

When the value of N is not the number of channels, for example, the 5.1 channel, with a known output position of an audio signal, the audio signal output unit 110 may extract channel based reproduction position information from the input signal and output the extracted channel based reproduction position information. Here, the channel based reproduction position information may be information associated with a position at which an audio signal of each channel is output.

For example, when the N channel audio signal is a stereo audio signal or a multichannel audio signal, for example, the 5.1 channel audio signal, which is formed in accordance with an international standard, an optimal position of a loudspeaker through which the audio signal of each channel is played may be determined.

Thus, the speaker signal generator 120 may identify the audio signal output position of each channel based solely on the value of N. Accordingly, the audio signal output unit 110 may not output the channel based reproduction position information.

However, when the N channel audio signal is a multichannel audio signal not in accordance with an international standard, the speaker signal generator 120 may not identify the audio signal output position of each signal based solely on the value of N. Here, the input signal may include the channel based reproduction position information associated with a position at which a channel based audio signal of the N channel audio signal is output, and the audio signal output unit 110 may extract the channel based reproduction position information from the input signal to output the channel based reproduction position information and thus, the speaker signal generator 120 may identify the audio signal output position of each channel.

Also, when the input signal is an audio bitstream encoded using an encoder such as an MP3, an Advanced Audio Coding (AAC), and an MPEG-H 3D Audio, the audio signal output unit 110 may decode the audio bitstream using an audio decoder and output the N channel audio signal. Here, the audio signal output unit 110 may analyze information included in the audio bitstream and output the channel based reproduction position information.

The speaker signal generator 120 may generate an M channel speaker signal using the audio signal output position of each channel and the N channel audio signal the received from the audio signal output unit 110. Here, a value of M may indicate a number of loudspeakers included in a sound bar 130, which is a speaker array through which a speaker signal is played. The value of N, which is the number of audio channels input to the speaker signal generator 120, and the value of M, which is the number of channels output by the speaker signal generator 120, may be equal to or differ from one another.

For example, when the value of N is greater than the value of M, the speaker signal generator 120 may identify an adjacent audio signal based on the audio signal output position of each channel and generate a single speaker signal using adjacent audio signals. When the value of N is less than the value of M, the speaker signal generator 120 may divide an audio signal and generate a plurality of speaker signals.

Also, the speaker signal generator 120 may determine a method of generating a speaker signal based on at least one of a position of a listener, an arrangement of the sound bar 130, and a listening environment such as a reflective environment.

Here, the speaker signal generator 120 may process the N channel audio signal using a rendering algorithm based on an output position of the audio signal for each channel and generate the M channel speaker signal.

For example, when the output position of the audio signal for each channel is a front channel, the speaker signal generator 120 may process the audio signal using a wave field synthesis rendering algorithm and generate at least one speaker signal corresponding to the audio signal.

When the output position of the audio signal for each channel is a side channel or a back channel, the speaker signal generator 120 may process the audio signal using a head related transfer function rendering algorithm, a beam-forming rendering algorithm, or a focused source rendering algorithm, and generate at least one speaker signal corresponding to the audio signal.

Also, when the output position of the audio signal for each channel is an upper layer channel or a lower layer channel that may be difficult to be expressed by the sound bar 130 having a single horizontal linear array, the speaker signal generator 120 may convert or downmix an upper layer channel signal or a lower layer channel signal to a middle layer channel signal and generate at least one speaker signal corresponding to the audio signal. The speaker signal generator 120 may delete high-level information from the upper layer channel or the lower layer channel, convert the upper layer channel or the lower layer channel to the middle layer channel, process the audio signal using the wave field synthesis rendering algorithm, and generate at least one speaker signal corresponding to the audio signal.

The sound bar 130 may be a speaker array module including M loudspeakers. Here, the sound bar 130 may amplify the M channel speaker signal received from the speaker signal generator 120 and output the amplified M channel speaker signal through a loudspeaker corresponding to each M channel speaker signal.

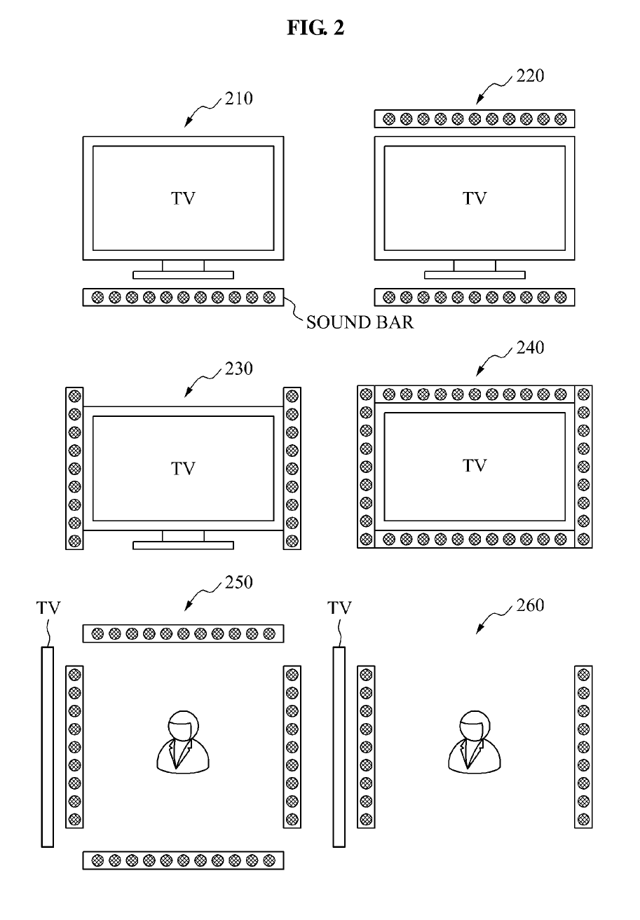

A detailed description of the arrangement and operation of the sound bar 130 will be provided with reference to FIG. 2.

When reproducing a sound field in the sound bar 130, the audio signal processing apparatus 100 may convert a multichannel audio signal to a speaker signal using channel based position information with respect to the multichannel audio signal and thus, a virtual channel may be formed at a position intended by an input signal manufacturer.

FIG. 2 illustrates an example of arrangement of a sound bar 130 of FIG. 1.

The sound bar 130 may virtually reproduce a multichannel audio signal using a three-dimensional sound field processing technology, for example, panning, wave field synthesis, beam forming, focused source, and head related transfer function, in a speaker array environment including the sound bar 130.

As illustrated in FIG. 2, the sound bar 130 may be generally provided as a single horizontal linear array 210 that may be disposed under a television (TV).

Also, to provide elevation, the sound bar 130 may be provided as a dual horizontal line array 220 disposed above and under the TV, a dual vertical line array 230 disposed on a left and a right side of the TV, or a window type array 240 surrounding the TV.

The sound bar 130 may be provided as an array 250 surrounding a listener or an array 260 disposed on a front and back side of the listener.

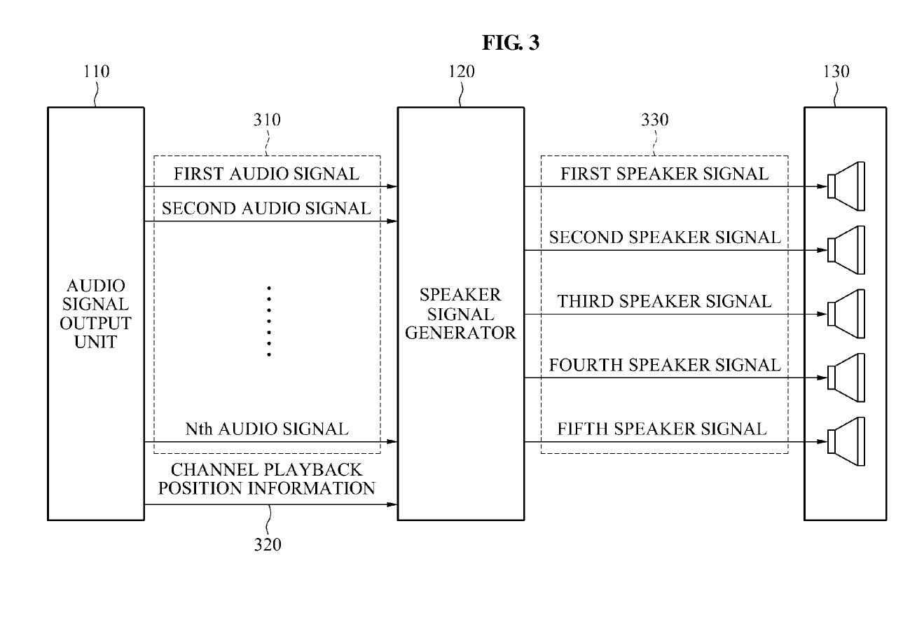

FIG. 3 is a diagram illustrating operation of the audio signal processing apparatus 100 of FIG. 1.

The audio signal output unit 110 may process an input signal and output an N channel audio signal 310 including a first audio signal, a second audio signal, and an Nth audio signal.

Also, the audio signal output unit 110 may extract channel based reproduction position information 320 from the input signal and output the extracted channel based reproduction information 320. Here, the channel based reproduction position information 320 may be information associated with a position at which an audio signal of each channel is output.

A speaker signal generator 120 may generate an M channel speaker signal 330 using an audio signal output position 320 of each channel and the N channel audio signal 310 received from the audio signal output unit 110. Here, a value of M may be a number of loudspeakers included in the sound bar 130 which may be a speaker array through which a speaker signal is played.

For example, when the sound bar 130 includes five loudspeakers as illustrated in FIG. 3, the speaker signal generator 120 may output the M channel speaker signal 330 including a first speaker signal, a second speaker signal, a third speaker signal, a fourth speaker signal, and a fifth speaker signal.

When a number of channels of a multichannel audio signal differs from a number of loudspeakers outputting an audio signal, the audio signal processing apparatus 100 may output a number of speaker signals corresponding to the number of the loudspeakers based on channel based reproduction position of the audio signal and thus, optimize the multichannel audio signal for the sound bar 130 to output the speaker signals.

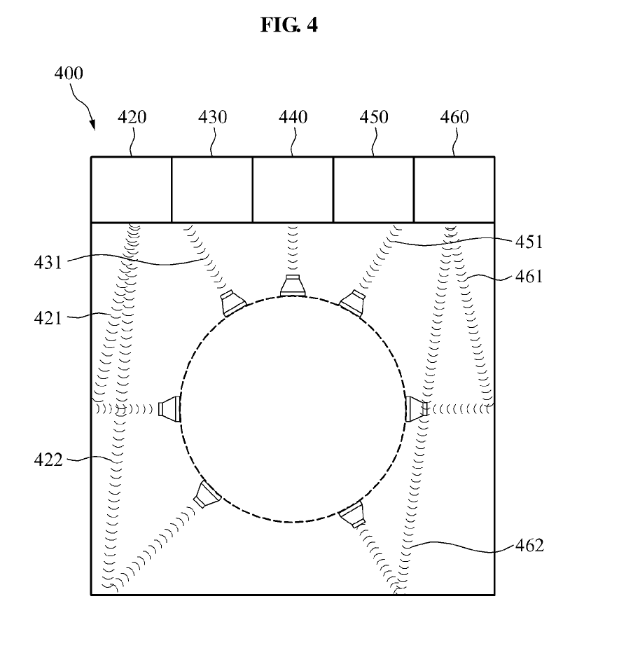

FIG. 4 illustrates an example of a speaker signal output by a sound bar 400 according to an embodiment of the present invention.

The sound bar 400 may include a first speaker 420, a second speaker 430, a third speaker 440, a fourth speaker 450, and a fifth speaker 460. When an input signal is a 5.1 channel, an audio signal processing apparatus 100 may output five speaker signals using a 5.1 channel audio signal. Here, the 5.1 channel audio signal may include a center (C) channel with output position disposed at a front center of a user, a left/right (L/R) channel with each output position disposed at front ±30 degrees of the user, a left side/right side (LS/RS) channel with each output position disposed at ±90 degrees of the user, and a left back/right back (LB/RB) channel with each output position disposed at ±150 degrees.

For example, the audio signal processing apparatus 100 may output a first speaker signal generated using the LS channel and the LB channel of the input signal, a second speaker signal generated using the L channel of the input signal, a third speaker signal generated using the C channel of the input signal, a fourth speaker signal generated using the R channel of the input signal, and a fifth speaker signal generated using the RS channel and the RB channel of the input signal.

The first speaker 420, the second speaker 430, the third speaker 440, the fourth speaker 450, and the fifth speaker 460 may correspondingly output the first speaker signal, the second speaker signal, the third speaker signal, the fourth speaker signal, and the fifth speaker signal.

As illustrated in FIG. 4, the first speaker signal output by the first speaker 420 may include a sound 421 reflected to a position of the LS channel and a sound 422 reflected to a position of the LB channel.

The second speaker signal output by the second speaker 430 may include a sound 431 reflected to a position of the L channel, and the third speaker signal output by the third speaker 440 may include a sound reflected to a position of the C channel.

Also, the fourth speaker signal output by the fourth speaker 450 may include a sound 451 reflected to a position of the R channel, and the fifth speaker signal output by the fifth speaker 460 may include a sound 461 reflected to a position of the RS channel and a sound 462 reflected to a position of the RB channel.

Accordingly, the sound bar 400 may reproduce a sound field of the 5.1 channel using the five loudspeakers.

The audio signal processing apparatus 100 may generate the second speaker signal using the L channel and the LS channel of the input signal and generate the fourth speaker signal using the R channel and the RS channel of the input signal. Here, the user may listen to both the sound 421 output by the first speaker 420 and a sound output by the second speaker 430 and reflected to the LS channel, and may recognize the sounds as a sound of the LS channel.

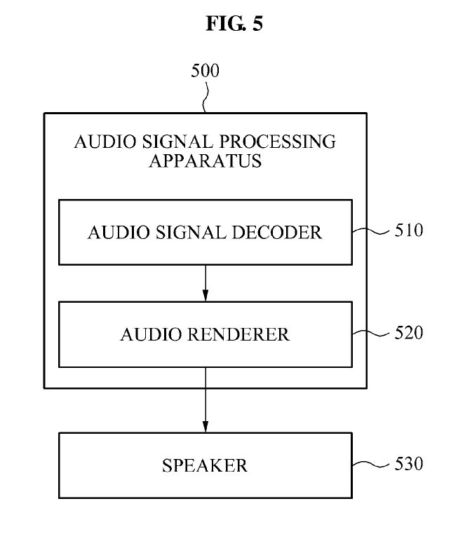

FIG. 5 is a diagram illustrating an audio signal processing apparatus 500 according to another embodiment of the present invention.

FIG. 5 illustrates an example of a configuration of an apparatus that may process an audio signal in a sound field reproducing environment including a speaker 530 in lieu of a sound bar.

Referring to FIG. 5, the audio signal processing apparatus 500 may include an audio signal decoder 510 and an audio renderer 520.

The audio signal decoder 510 may decode an N channel audio signal and channel based reproduction position information from an audio bitstream received by the audio signal processing apparatus 500.

The audio signal decoder 510 may transmit the decoded N channel audio signal and the channel based reproduction position information to the audio renderer 520.

The audio renderer 520 may render the N channel audio signal into an M channel speaker signal using the channel based reproduction position information and speaker position information with respect to a speaker outputting a speaker signal. Here, the speaker position information may be manually input to the audio renderer 520 by a user installing the speaker 530 or transmitted to the audio renderer 520 from each speaker by identifying a position of each speaker.

The M channel speaker signal rendered by the audio renderer 520 may include a sound field characteristic of the N channel audio signal. The audio renderer 520 may perform the rendering to allow the M channel speaker signal to maintain the sound field characteristic of the N channel audio signal to the maximum.

When a value of N is greater than a value of M, the audio renderer 520 may identify an adjacent audio signal based on audio signal output position of each channel and render a plurality of adjacent audio signals into a single speaker signal.

When the channel based reproduction position information differs from the speaker position information, the audio renderer 520 may render the N channel audio signal into the M channel speaker signal based on a difference between the channel based reproduction position information and the speaker position information.

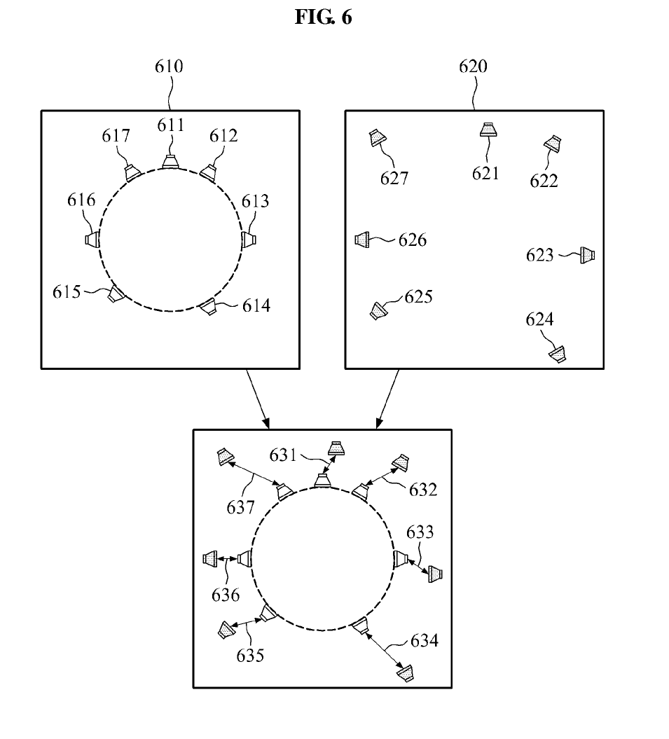

A detailed description of the rendering performed by the audio renderer 520 when the channel based reproduction position information differs from the speaker position information will be provided with reference to FIG. 6.

The speaker 530 may amplify the M channel speaker signal output by the audio renderer 520 and output the amplified speaker signal.

The audio signal processing apparatus 500 may convert a multichannel audio signal to a speaker signal using a position of the speaker 530 and channel based position information for the multichannel audio signal and thus, a virtual channel may be formed at a position intended by an input signal manufacturer, although the position of the speaker 530 differs from a position of each channel.

FIG. 6 is a diagram illustrating a relationship between an audio signal and a speaker signal according to an embodiment of the present invention.

The audio signal decoder 510 of FIG. 5 may output an N channel audio signal 610 including a C channel 611, an R channel 612, an RS channel 613, an RB channel 614, an LB channel 615, an LS channel 616, and an L channel 617.

Also, the audio renderer 520 may receive speaker position information 620 indicating each position of a first speaker 621 outputting the C channel 611, a second speaker 622 outputting the R channel 612, a third speaker 623 outputting the RS channel 613, a fourth speaker 624 outputting the RB channel 614, a fifth speaker 625 outputting the LB channel 615, a sixth speaker 626 outputting the LS channel 616, and a seventh speaker 627 outputting the L channel 617.

As illustrated in FIG. 6, the first speaker 621 outputting the C channel 611 and a channel based reproduction position of the C channel 611 may differ from one another. Also, the second speaker 622 outputting the R channel 612 and the channel based reproduction position of the R channel 612, the third speaker 623 outputting the RS channel 613 and the channel based reproduction position of the RS channel 613, the fourth speaker 624 outputting the RB channel 614 and the channel based reproduction position of the RB channel 614, the fifth speaker 625 outputting the LB channel 615 and the channel based reproduction position of the LB channel 615, the sixth speaker 626 outputting the LS channel 616 and the channel based reproduction position of the LS channel 616, and the seventh speaker 627 outputting the L channel 617 and the channel based reproduction position of the L channel 617 may differ from one another.

Here, the audio renderer 520 of FIG. 5 may render the C channel 611 into a first speaker signal corresponding to the first speaker 621 based on a difference in a direction and a distance between the position of the first speaker 621 and the channel based reproduction position of the C channel 611. The first speaker signal output by the first speaker 621 may reproduce a closest sound field when the C channel 611 is output at the channel based reproduction position of the C channel 611.

The audio renderer 520 may render the R channel 612 into a second speaker signal corresponding to the second speaker 622 based on a difference in a direction and a distance between the position of the second speaker 622 and the channel based reproduction position of the R channel 612, and render the RS channel 613 into a third speaker signal corresponding to the third speaker 623 based on a difference in a direction and a distance between the position of the third speaker 623 and the channel based reproduction position of the RS channel 613.

The audio renderer 520 may render the RB channel 614 into a fourth speaker signal corresponding to the fourth speaker 624 based on a difference in a direction and a distance between the position of the fourth speaker 624 and the channel based reproduction position of the RB channel 614, and render the LB channel 615 into a fifth speaker signal corresponding to the fifth speaker 625 based on a difference in a direction and a distance between the position of the fifth speaker 625 and the channel based reproduction position of the LB channel 615.

Also, the audio renderer 520 may render the LS channel 616 into a sixth speaker signal corresponding to the sixth speaker 626 based on a difference in a direction and a distance between the position of the sixth speaker 626 and the channel based reproduction position of the LS channel 616, and render the L channel 617 into a seventh speaker signal corresponding to the seventh speaker 627 based on a difference in a direction and a distance between the position of the seventh speaker 627 and the channel based reproduction position of the L channel 617.

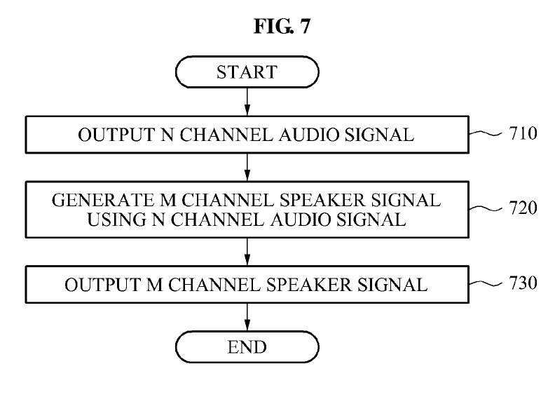

FIG. 7 is a flowchart illustrating an audio signal processing method according to an embodiment of the present invention.

The audio signal processing method illustrated in FIG. 7 may be performed by the audio signal processing apparatus 100 illustrated in FIG. 1.

In operation 710, the audio signal output unit 110 of FIG. 1 may process an input signal and output an N channel audio signal. Here, a value of N may be a number of all channels of audio signals output by the audio signal output unit 110, and N may be one of channels used by a multichannel audio signal.

When the value of N is not a number of channels indicating an audio signal output position of each channel, the audio signal output unit 110 may extract channel based reproduction position information from the input signal and output the extracted channel based reproduction position information. Here, the channel based reproduction position information may be information associated with a position at which an audio signal of each channel is output.

In operation 720, the speaker signal generator 120 of FIG. 1 may generate an M channel speaker signal using the audio signal output position of each channel and the N channel audio signal output in operation 710.

For example, when the value of N is greater than a value of M, the speaker signal generator 120 may identify an adjacent audio signal based on the audio signal output position of each channel and generate a single speaker signal using a plurality of adjacent audio signals. When the value of N is less than the value of M, the speaker signal generator 120 may divide an audio signal and generate a plurality of speaker signals.

Here, the speaker signal generator 120 may process the N channel audio signal using a rendering algorithm based on the audio signal output position of each channel and generate the M channel speaker signal.

In operation 730, the sound bar 130 of FIG. 1 may amplify the M channel speaker signal generated in operation 720 and output the amplified M channel speaker signal through a loudspeaker corresponding to each M channel speaker signal and thus, reproduce a sound field.

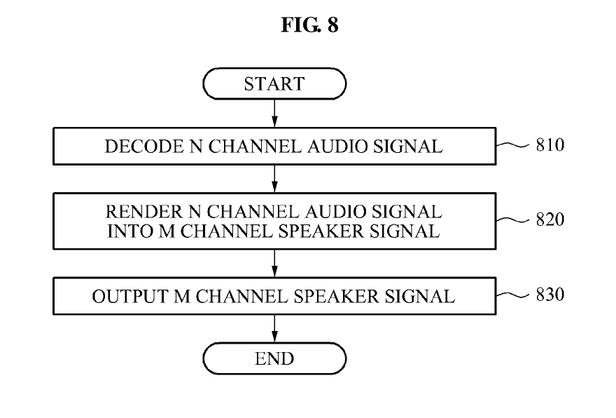

FIG. 8 is a flowchart illustrating an audio signal processing method according to another embodiment of the present invention.

The audio signal processing method illustrated in FIG. 8 may be performed by the audio signal processing apparatus 500 illustrated in FIG. 5.

In operation 810, an audio signal decoder 510 of FIG. 5 may decode an N channel audio signal and channel based reproduction position information from an audio bitstream received by the audio signal processing apparatus 500. The audio signal decoder 510 may transmit the decoded N channel audio signal and the channel based reproduction position information to the audio renderer 520 of FIG. 5.

In operation 820, the audio renderer 520 may render the N channel audio signal decoded in operation 810 into an M channel speaker signal using speaker position information with respect to a speaker outputting a speaker signal and the channel based reproduction position information decoded in operation 810.

The M channel speaker signal rendered by the audio renderer 520 may include a sound field characteristic of the N channel audio signal. When a value of N is greater than a value of M, the audio renderer 520 may identify an adjacent audio signal based on an audio signal output position of each channel and render a plurality of adjacent audio signals into a single speaker signal.

When the channel based reproduction position information differs from the speaker position information, the audio renderer 520 may render the N channel audio signal into the M channel speaker signal based on a difference between the channel based reproduction position information and the speaker position information.

In operation 830, a speaker 530 of FIG. 5 may amplify the M channel speaker signal rendered in operation 820 and output the amplified speaker signal.

When reproducing a sound field in a sound bar, an audio signal processing apparatus according to an embodiment of the present invention may convert a multichannel audio signal to a speaker signal using channel position information for the multichannel audio signal and thus, a virtual channel may be formed at a position intended by an input signal manufacturer.

Also, when reproducing a sound field in a general speaker environment, an audio signal processing apparatus according to another embodiment of the present invention may convert a multichannel audio signal to a speaker signal using a position of a speaker and channel position information for the multichannel audio signal and thus, a virtual channel may be formed at a position intended by an input signal, although the position of the speaker differs from a position of the channel.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. An audio signal processing apparatus, comprising:
an audio signal output unit to process an input signal and output an N channel audio signal; and
a speaker signal generator to generate an M channel speaker signal using an audio signal output position of each channel and the N channel audio signal.

2. The apparatus of claim 1, wherein N is one of channels used by a multichannel audio signal, and a value of M is a number of loudspeakers in a speaker array through which a speaker signal is played.

3. The apparatus of claim 1, wherein when a value of N is not a number of channels indicating the audio signal output position of each channel, the audio signal output unit extracts channel based reproduction position information from the input signal to output the extracted channel based reproduction position information.

4. The apparatus of claim 1, wherein when the value of N is greater than the value of M, the speaker signal generator identifies an adjacent audio signal based on the audio signal output position of each channel and generates a single speaker signal using adjacent audio signals.

5. The apparatus of claim 1, wherein when the value of N is less than the value of M, the speaker signal generator divides an audio signal and generates a plurality of speaker signals.

6. The apparatus of claim 1, wherein the speaker signal generator processes the N channel audio signal using a rendering algorithm based on the audio signal output position of each channel and generates the M channel speaker signal.

7. The apparatus of claim 6, wherein when the audio signal output position of each channel is a front channel, the speaker signal generator processes the audio signal using a wave field synthesis rendering algorithm and generates at least one speaker signal corresponding to the audio signal.

8. The apparatus of claim 6, wherein when the audio signal output position of each channel is a side channel or a back channel, the speaker signal generator processes the audio signal using a focused source rendering algorithm and generates at least one speaker signal corresponding to the audio signal.

9. The apparatus of claim 6, wherein when the audio signal output position of each channel is a side channel or a back channel, the speaker signal generator processes the audio signal using a beam-forming rendering algorithm and generates at least one speaker signal corresponding to the audio signal.

10. The apparatus of claim 1, wherein when the input signal is an encoded audio bitstream, the audio signal output unit decodes the audio bitstream using an audio decoder and outputs the N channel audio signal.

11. An audio signal processing apparatus, comprising:
an audio signal decoder to decode an N channel audio signal and channel based reproduction position information from an audio bitstream; and
an audio renderer to render the N channel audio signal into an M channel speaker signal using the channel based reproduction position information and speaker position information with respect to a speaker outputting a speaker signal.

12. The apparatus of claim 11, wherein when a value of N is greater than a value of M, the audio renderer identifies an adjacent audio signal based on audio signal output position of each channel and renders a plurality of adjacent audio signals into a single speaker signal.

13. The apparatus of claim 11, wherein when the channel based reproduction position information differs from the speaker position information, the audio renderer renders the N channel audio signal into the M channel speaker signal based on a difference between the channel based reproduction position information and the speaker position information.

14. The apparatus of claim 11, wherein the M channel speaker signal comprises a sound field characteristic of the N channel audio signal.

15. An audio signal processing method, comprising:
outputting an N channel audio signal by processing an input signal; and
generating an M channel speaker signal using an audio signal output position of each channel and the N channel audio signal.

16. The method of claim 15, wherein when a value of N is not a number of channels indicating the audio signal output position of each channel, the outputting is performed by extracting channel based reproduction position information from the input signal.

17. The method of claim 15, wherein the generating is performed by processing the N channel audio signal using a rendering algorithm based on the audio signal output position of each channel.

18. The method of claim 17, wherein when the audio signal output position of each channel is a front channel, the generating comprises processing the audio signal using a wave field synthesis rendering algorithm and generating at least one speaker signal corresponding to the audio signal.

19. The method of claim 17, wherein when the audio signal output position of each channel is a side channel or a back channel, the generating comprises processing the audio signal using a beam-forming rendering algorithm and generating at least one speaker signal corresponding to the audio signal.

20. (canceled)
